(19) United States
(12) Patent Application Publication
(10) Pub. No.: US 2024/0144311 A1
(43) Pub. Date: May 2, 2024

(54) INTELLIGENT AND INTERACTIVE SHOPPING ENGINE FOR IN-STORE SHOPPING EXPERIENCE

(71) Applicants: Nat Mani, San Jose, CA (US); Lali Nathan, San Jose, CA (US)

(72) Inventors: Nat Mani, San Jose, CA (US); Lali Nathan, San Jose, CA (US)

(21) Appl. No.: 18/241,854

(22) Filed: Sep. 2, 2023

Related U.S. Application Data
(63) Continuation-in-part of application No. 18/101,938, filed on Jan. 26, 2023.
Application No. 18/101,938 is a continuation of application No. 16/109,599, filed on Aug. 22, 2018, now Pat. No. 11,568,435.
(60) Provisional application No. 62/548,733, filed on Aug. 22, 2017.

(51) Int. Cl. G06Q 30/0207; G06Q 10/067; G06Q 50/18

(52) U.S. Cl. CPC G06Q 30/0222; G06Q 10/067; G06Q 50/188

(57) ABSTRACT

A highly immersive, interactive and addictive platform for shopping. The system may provide both an online and retail experience through an immersive environment that enables repeat transactions and enables add-on sales to offers that are completely unique for each customer. The interactive shopping experience generates one or more bundles to any actual or potential user purchase to create a dynamic and favorable shopping experience for the particular user. The bundles are customized for each user based on user history with a merchant, product data, and merchant data, In addition to customizing the bundles, the decision of whether or not to offer one or more bundles is made only confirming that the current time is desirable to make an offer of bundles to the particular user.

### CROSS REFERENCE TO RELATED APPLICATIONS

This application is a continuation of U.S. application Ser. No. 16/109,599, titled “Intelligent and Interactive Shopping Engine,” filed Aug. 22, 2018, which claims the priority benefit of U.S. Provisional Application Ser. No. 62/548,733, titled “Intelligent and Interactive Shopping Engine,” filed Aug. 22, 2017, the disclosures of which are incorporated herein by reference.

### BACKGROUND

When purchasing some product, some shoppers purchase items online rather than taking the time to look at an item in person at a brick and mortar store having a physical location. With other products, some shoppers prefer to go inside a physical store to look at a product in person before purchasing it. Typical online shopping experiences allow a user to browse one or more products, select those products for purchase, and complete the purchase. A shopping experience at a physical storefront is similar, but items for sale that are seen in person are often not as easy to find and many products may be out of stock—and therefore unavailable for viewing. Some merchants offer a coupon for a product and offers sales to all customers on an equal basis.

Shopping online and through brick-and-mortar store is generally a very static experience. A user finds a product they are looking for, takes it to a virtual or physical checkout, and purchases the product. With the development of online shopping, there is often very little incentive for a user to come back to a particular retailer, and most online shopping experiences as well as brick-and-mortar experiences become a search for the best price. What is needed is an improved shopping experience provided to users to encourage them to continue shopping at a particular merchant.

### SUMMARY

The present technology, roughly described, provides a highly immersive, interactive and addictive platform for shopping. The system may provide both an online and retail experience through an immersive environment that enables repeat transactions and enables add-on sales to offers that are completely unique for each customer. The interactive shopping experience generates one or more bundles to any actual or potential user purchase to create a dynamic and favorable shopping experience for the particular user. The bundles can be customized for each user based on user history with a merchant, product data, merchant data, user's internet browser history, and system prompted questions to ascertain the interest of a user in particular items. In addition to customizing the bundles, the decision of whether or not to offer one or more bundles is made only confirming that the current time is desirable to make an offer of bundles to the particular user based on the probability the user may accept the offer or other user preferences such as the frequency with which they desire to receive offers. A bundle may include one or more products for sale, discounted or free shipping, discounts for the same or a different product, or a combination of these and other offers. Interactive real-time negotiations can target price but may also target the type of bundle, number of items in the bundle, or discount.

In addition to providing customized bundles at a desired time, the present system provides a buyer with the ability to negotiate one-on-one with the system on a real-time basis. The negotiation may be handled by logic of the present system based on bundled products, price, discount, shipping cost, reward points or bundle mix parameters. Price parameters may be set by a merchant, including an average price, maximum price, and minimum price for each item, as well as the expected number of items to be sold over a specific period of time. The present system can then combine multiple items and present an offer in a bundle, while meeting the price expectation of the merchant for individual items. Negotiations are not limited to just price—the user can negotiate for a different bundle combination or expand the bundle by adding more products or request reward points in lieu of a price discount-all such types of negotiations are possible using this technology.

The present technology may provide the bundles and negotiation experience in both on-line and in brick-and-mortar store environments. When a user is in a physical store, the present system can provide an augmented reality feature that allows a user to enter a geographical location, such as a merchant's store, and interact with custom animations and virtual placements of items for sale. The interactions, items for sale, and prices may be generated specifically for the user and may not be visible for any other individual and is unique to the user. When a user is online, for example via a merchant webpage, the user can view items of interest, interact with the sales engine to negotiate the type of bundle, or the cost of shipping, or a price or a discount or reward points, and purchase items in a unique, interactive, and addictive manner.

In an embodiment, the present technology includes a method for providing an intelligent shopping experience. User merchant data and product data are received from a merchant server by an application server. A bundling timing score related to whether to prepare a bundle for a user at the current time is generated. The bundle offer includes an item of interest to the user and a benefit. The system can then present, based on the bundle timing score, one or more bundles for the user, each of the one or more bundles generated from the user merchant data and the product data. One or more bundles are provided to the user, structured unique to a particular user based on user profile, merchant influenced options, and also based on the user's response to system prompted questions. The interaction of the user and the merchant is in all cases dynamic and it is programmatically executed.

### BRIEF DESCRIPTION OF THE FIGURES

FIG. 1 is a block diagram of an intelligent an interactive shopping engine.

FIG. 2 is a block diagram of an application for providing an intelligent an interactive shopping engine.

FIG. 3 is a method for providing an intelligent an interactive shopping engine.

FIG. 4 is a method for confirming a time to provide a bundle.

FIG. 5 is a method for generating a user intent vector.

FIG. 6 is a method for preparing one or more bundles for a user.

FIG. 7 is a method for negotiating a purchase between a user and an automated agent.

FIGS. 8A-8F illustrates an augmented reality implementation for an intelligent and interactive shopping engine.

FIGS. 9A-9C illustrate a flowchart of an exemplary user purchase experience.

FIG. 10 illustrates a diagram of a geographical location for providing a customized interactive shopping experience.

FIG. 11A provides more detail for a product and a corresponding scannable code within the geographical location of FIG. 10.

FIG. 11B illustrates an augmented view of the product and corresponding scannable code of FIG. 11A and a graphic through the display of a computing device.

FIG. 11C provides more detail for a scannable code within the geographical location of FIG. 10.

FIG. 11D illustrates an augmented view of the scannable code of FIG. 11C and a graphic through the display of a computing device.

FIG. 12 is a method for providing an on-site intelligent and interactive shopping experience.

FIG. 13 is a method for providing updated information to user regarding products and offer the user navigates a store.

FIG. 14 is a method for processing user offers.

FIG. 15 is a method for communicating offers to a user.

FIG. 16 is a method for providing bundle data to the user as an offer.

FIG. 17 is a method for processing a user shopping list is a bundle.

FIG. 18 is a block diagram of a computer system for implementing the present technology.

### DETAILED DESCRIPTION

The present technology, roughly described, provides a highly immersive, interactive, personal and addictive platform for shopping. The system may provide both an online and retail experience through an immersive environment that enables repeat transactions and enables add-on sales to offers that are completely unique for each customer. The interactive shopping experience generates one or more bundles to any actual or potential user purchase to create a dynamic and favorable shopping experience for the particular user. The bundles are customized for each user based on user history with a merchant, product data, and merchant data, users' internet browsing history and based on system prompted questions to ascertain the interest of a user in particular items. In addition to customizing the bundles, the decision of whether or not to offer one or more bundles is made only confirming that the current time is desirable to make an offer of bundles to the particular user based on the probability the user may accept the offer or other user preferences such as the frequency with which they desire to receive offers. A bundle may include one or more products for sale, or a combination of a product plus free shipping, product plus reward points, product plus discounts for the same or a different product or such similar combinations. Interactive real-time negotiations may target price but may also target the type of bundle, number of items in the bundle, or discount.

In addition to providing customized bundles at a desired time, the present system provides a buyer with the ability to negotiate one-on-one with the system on a real-time basis. The negotiation may be handled by logic of the present system based on bundled products, price, discount, shipping cost, reward points or bundle mix parameters. Price parameters may be set by a merchant, including an average price, maximum price, and minimum price, as well as the expected number of items to be sold over a specific period of time. The technology will then have the ability to combine multiple items and present an offer in a bundle, while meeting the price expectation of the merchant for individual items. Negotiations are not limited to just price—the user can negotiate for a different bundle combination or expand the bundle by adding more products or request reward points in lieu of a price discount-all such types of negotiations are possible using this technology. In some instances, a particular merchant may provide user merchant data for that particular store as well as other merchants, for situations when a bundle may be provided to a user to offer a product or service from a different merchant.

The present technology may provide the bundles and negotiation experience in both on-line and in brick-and-mortar store environments. When a user is in a physical store, the present system can provide an augmented reality feature that allows a user to enter a geographical location, such as a merchant's store, and interact with custom animations and virtual placements of items for sale. The interactions, items for sale, and prices may be generated specifically for the user and may not be visible for any other individual and is unique to the user. When a user is online, for example via a merchant webpage, the user can view items of interest, interact with the sales engine to negotiate the type of bundle, or the cost of shipping, or a price, or a discount or reward points and purchase items in a unique, interactive, and addictive manner.

Decisions as to when to make a bundle offer to a user, the generation of the bundles, and negotiation activities are generated in a real-time basis based on the most up to date user merchant data, merchant data, and product data. For this reason, the bundles are well suited to provide the most value possible to both the user and the merchant behind the bundle offer.

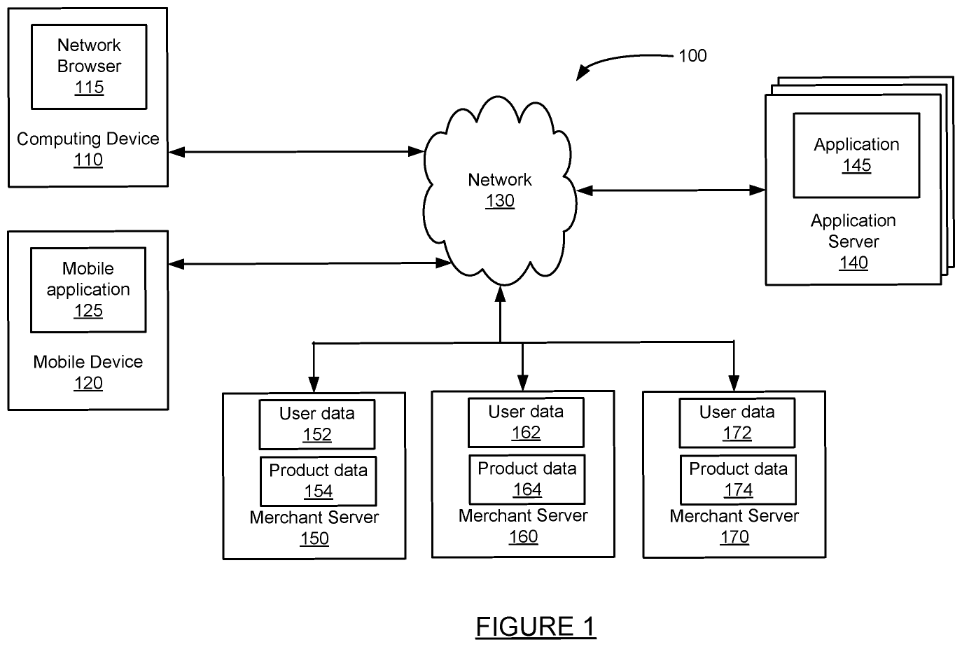

FIG. 1 is a block diagram of an exemplary system for providing an intelligent and interactive shopping system. The block diagram of FIG. 1 includes computing device 110, mobile device 120, network 130, application server 140, and merchant servers 150-180.

Computing device 110 may include any device suitable for communicating with application server 140 over network 130, such as a desktop computer, a workstation, or any other computing device including devices that interact just using voice commands (such as Amazon Echo, Google Home, etc.). Computing device 110 may include network browser 115. Network browser 115 may be an application stored in memory of computing device 110, executed by one or more processors to receive, load, and output one or more content pages received from application 145, receive input through an input device computing device 110, and send data to application 145. In some instances, network browser 115 may be a web browser and provide web page content received over network 130, for example a webpage received from application server 140. The webpage content may be used to receive input and provide output according to functionality described herein.

Mobile device 120 may include a smart phone, laptop computer, tablet computer, or any other computer that may be considered mobile in nature. In some instances, device 120 and/or computing device 110 may each be implemented as any device—mobile or other—that can support virtual reality (VR) and augmented reality (AR) technology and provide an AR or VR experience to a user. Mobile device 120 may also include a device that provides in-ear voice technology.

Mobile device 120 may include mobile application 125. Mobile application 125 may communicate with application 145 on application server 140 to implement functionality described herein.

Mobile application 125 may, for example, receive user input to and navigate through webpages provided by a merchant server or application server. Mobile application 125 may also collect geographical data for the location of the device and report that data to merchant server 150 and application server 140. Mobile application 125 may further provide an augmented reality (AR) experience when a camera of the mobile device is directed towards a product, display, or other portion of a physical store and the corresponding camera view as well as additional graphics, text, icons or other content is provided through display of mobile device 120. In some instances, mobile application 125 may be implemented as a mobile application compatible with an IOS or android operating system.

Network 130 may be used to communicate data between one or more machines, including computing device 110, mobile device 120, application server 140, video storage 150, training data 160, and training video 170. Network 130 may be implemented by one or more public networks, private networks, an intranet, the Internet, a wireless or Wi-Fi network, a cellular network, or any other network suitable for communicating data.

Application server 140 may communicate with devices 110-120 as well as servers 150-170. Application server 140 may include one or more machines that implement one or more physical or logical application servers. In some instances, application server 140 may include one or more machines that implement one or more physical or logical web servers (not illustrated in FIG. 1) that communicate with network 130 and one or more physical and/or logical application servers. Application server 140 may also communicate with one or more physical or logical data stores (not illustrated in FIG. 1) at which data including user merchant data, product data, and merchant data can be stored.

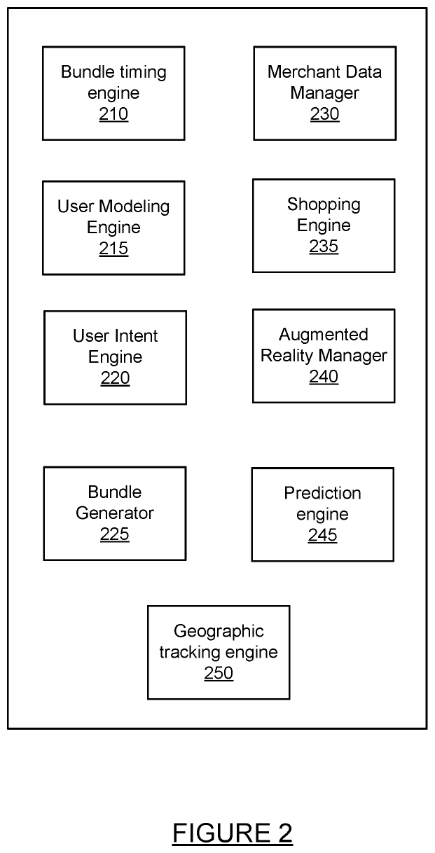

Application 145 may reside in memory of one or more application servers 140 and may be executed to provide functionality described herein. Application 145 may have logic and artificial intelligence functionality to determine individual pricing information for objects, negotiate and/or haggle item prices and bundles with a user, provide an augmented reality experience through mobile application 125, and may communicate with devices 110-120 to provide an interface to communicate with the user. Application 145 is discussed in more detail below with respect to the block diagram of FIG. 2.

Merchant servers 150-180 may each provide one or more products or items for sale through the system provided by application server 140. Each of merchant servers 150-170 may include user merchant data (152, 162, 172) and product data (154, 14, 174). User merchant data may include user purchases, online pages visited, clicks received for a user, merchant related geographical locations visited by the user, in-store purchases, a user shopping wish list, a number of shopping points accumulated for the user, and other data capable of being selected by a merchant when a user shops within a physical merchant store and/or accesses a web service provided by the merchant.

Product data may include product descriptions, including text and images, a minimum price and maximum price at which the product may be sold, the number of items expected to be sold over a period of time, the possible pairing of this item with another to create a bundle and other data. Product data may also include category data, such as the color, size, type of product, and other data. With this information, application server 140 may provide items of interest to users through computing device 110 or mobile device 120. The items provided to a user may be in response to a user search, items determined to be of interest to a user based on user purchase history and other data, and other items. In some instances, a merchant may provide a discount to a particular user without providing the same discount to other users, thereby potentially selling the product at a price which is more desirable to a merchant and on terms more agreeable to each individual purchaser. In some instances, a seller may only pay a fee to administrators of the present selling engine if there is a successful commercial transaction involving the merchant.

Merchant servers 150-170 may also include merchant data which may be provided to application server 140. The merchant data may include data such as minimum or average discount desire to provide a particular user, the time a product has been in inventory, preferred user qualities for particular discounts, desired revenue, desired margins, promotional investments, and other data.

FIG. 2 is a block diagram of an application for providing an intelligent and interactive shopping engine. Application 200 of FIG. 2 provides more detail of application 145 illustrated in FIG. 1. Application 200 includes bundle timing engine 210, user modeling engine 215, user intent engine 220, bundled generator 225, merchant data manager 230, shopping engine 235, and augmented reality manager 240. Each module of application 200 may be executed to perform all or a portion of the functionality discussed herein. Though several modules are illustrated, one or more modules of FIG. 2 may be combined or divided into multiple modules. Additionally, the illustrated modules are intended to be exemplary, and other modules or configurations of code may be implemented to achieve the functionality described herein.

Bundle timing engine 210 may be executed to generate bundle timing scores. User modeling engine 215 may model user shopping history. By modeling the user shopping history, engine 215 can identify bundles that the user may be interested in. User intent engine 220 may determine a user's intent to complete a purchase at a particular time. The intent engine may generate an intent score or vector that, when compared to a threshold, may determine whether a user is likely to make a particular purchase.

Bundle generator 225 may generate one or more bundles to submit to a user. The bundle generator 225 may also include modeling, artificial intelligence, machine learned logic and other logic that may receive and process counteroffers to a particular bundle, determine if those counteroffers are acceptable, and accept or propose an alternative bundle to a user. Merchant data manager 230 may process and analyze merchant data. The merchant data may include discounts, inventory, shipping information, and other data.

Shopping engine 235 may generate, manage, and provide shopping information to a user, such as for example through a mobile application or web service provided by application 200. The shopping information may be provided directly to a user, through a mobile application or network content page (e.g., website) provided by application server 140 and displayed through a computing device (for example through computing device 110 or mobile device 120), or through a mobile app or content page provided by a particular merchant.

Augmented reality manager 240 may provide an augmented reality experience to a user through a user's mobile device. Augmented reality experience can be provided within a merchant's physical store or other location. In some instances, the augmented reality experience may direct a user to different portions of the store with graphical for textual icons or other information, provide bundles to a user, and otherwise interact with a user and provide additional rich content to the user.

Prediction engine 245 may include one or more models for generating one or more predictions. The one or more models may implement artificial intelligence as one or more algorithms that can be trained to predict the likelihood of a particular bundle being accepted, the desirability of a product to be included in a bundle, and/or other predictions.

Geographic tracking engine 250 may obtain geographical position information for a user device and process the position data within the present system. Processing the position data may include determining a user location within a geographical location (e.g., brick and mortar store), determining a user proximity to a marker, product, or other item of interest within a store, and determining other position-based tasks.

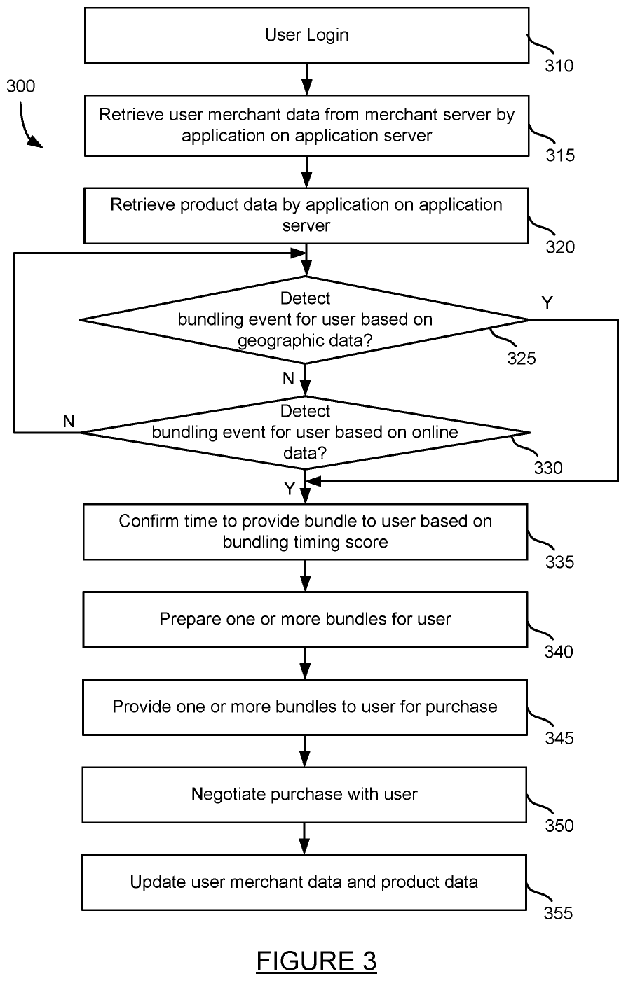

FIG. 3 is a method for providing an intelligent an interactive shopping engine. A user logs in at step 310. User login may be broadly interpreted as creating a user account, executing a mobile application, logging into a web service, or simply determining that a user's physical location is detected at or near a brick-and-mortar store for a merchant.

User merchant data is retrieved from a merchant server by an application on an application server at step 315. The merchant data may include user purchase information, including online webpages visited, clicks received, and items bought. The user merchant data may also include in-store visit data, including visits to a store, items purchased, items returned, and other user merchant data. In some instances, the user merchant data may be for more than one merchant. For example, a particular merchant may provide user merchant data for that particular store as well as other merchants, for situations when a bundle may be provided to a user to offer a product or service from a different merchant.

Product data can be retrieved by an application on the application server at step 320. Product data can include inventory, information regarding related products, category information for a product, and other data.

After retrieving data, a determination may be made as to whether a bundling event is detected for a user based on geographic data at step 325. In some instances, user might make a visit to a physical brick-and-mortar store for the merchant. Mobile device on the user's phone may detect the user's location at the store, near the store (e.g., in or near a mall at which the store is located), and generate an event or notification message in response to detecting the user's location at the store. The bundling event may also be an actual purchase by the user at a physical store. If a bundling event is detected for user based on geographical data, the method of FIG. 3 continues to step 335.

If a bundling event is not detected based on geographical data, a determination is made as to whether a bundling event is detected for a user based on online data at step 330. Similar to visiting a physical store, a user may visit a website provided by the merchant and click on a particular product or service offer. That click, or visit of the particular page associated with the product, could trigger a bundling event for the user. Similarly, if a user exhibits a pattern while navigating online web site pages that is similar to a previous pattern that resulted in a purchase through the website, that may also initiate a bundling event for the user. If an online bundling event is detected for the user, the method continues to step 335. Otherwise, the method continues to determine whether any bundling event is detected at step 325 and/or 330.

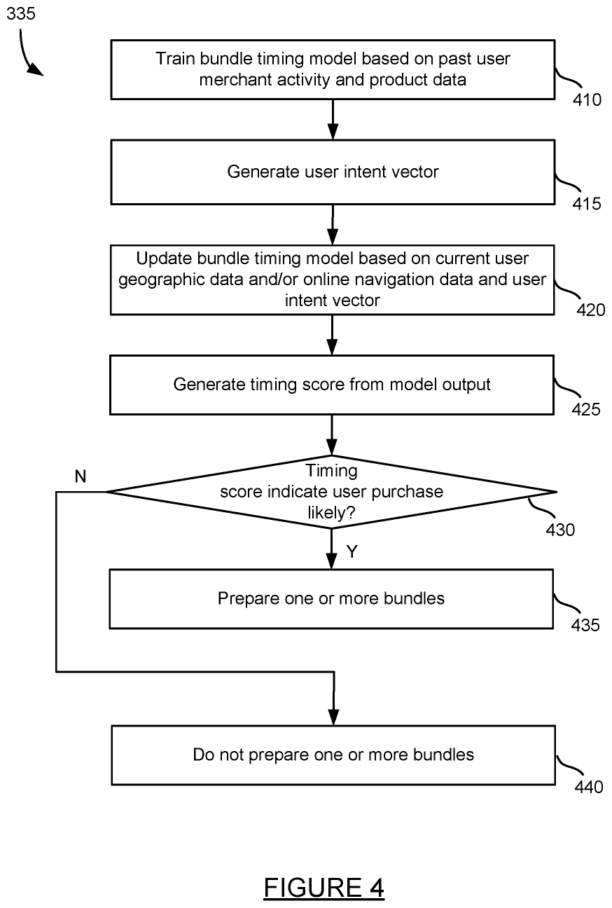

A confirmation of a time to provide a bundle to a user based on a bundling time score is made at step 335. Determining a bundling time score to confirm a time at which to potentially provide a bundle to a user may include determining if a current time (or other time) is a good time to offer the bundle. Generating the bundling time score may utilize user merchant data, intent score, and other data. Generating a bundling timing score is discussed in more detail with respect to the method of FIG. 4.

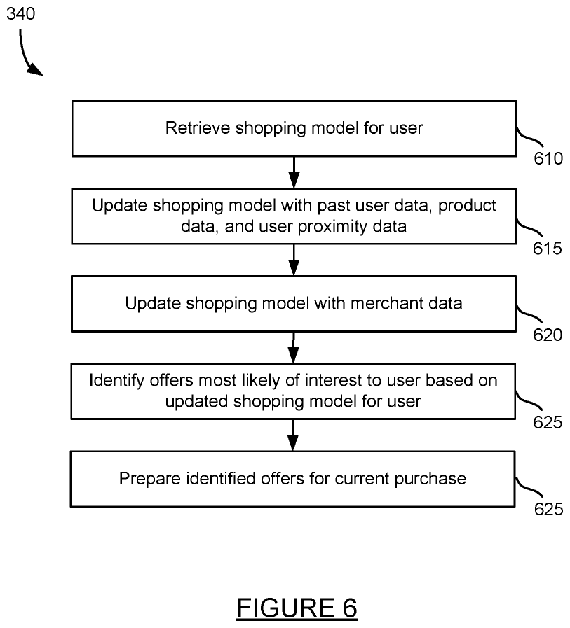

One or more bundles are prepared for a user at step 340. The bundles may be prepared from user merchant history, product data, and merchant data. In some instances, initially, a user may be “boxed” or categorized similarly to other users having similar basic traits. As the set of user data modifies or the user performs additional shopping, the user shopping can be modeled in a more customized matter. As such, bundles prepared for user may be customized as well. More detail for preparing bundles for user is discussed with respect to the method of FIG. 6.

One or more bundles may be provided to the user for purchase at step 345. The bundles may be provided to the user in whichever way the user is interacting with the merchant service. If the user is navigating a website, the merchant service may provide a network content page, for example a webpage, to provide one or more bundles. If the user is shopping through a mobile app, bundles may be provided through the mobile app on a mobile device. If a user is navigating around a physical store, the bundles may be provided to a user through the mobile device in any of number of ways, including but not limited to information provided by a mobile app, an augmented reality experience through the mobile application, text message, a sales associate, or other mechanism.

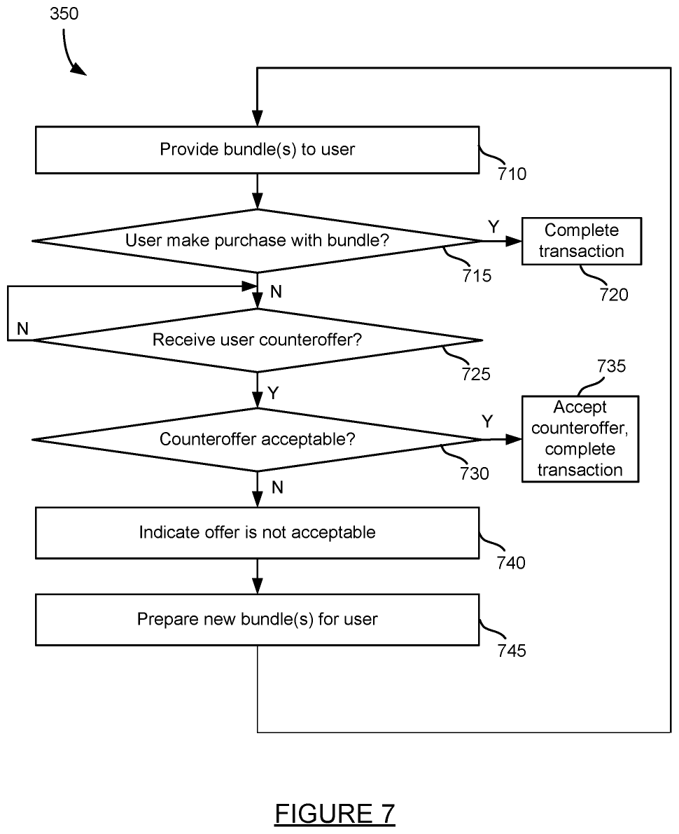

An agent of the present system may negotiate a purchase with the user at step 350. A user may accept, reject, or provide a counteroffer to any of one or more bundles provided to the user. In some instances, if one or more bundles provided to a user are not accepted by the user, the user or the agent may initiate a negotiation process in attempt to achieve a sale or purchase of a product. Negotiating a purchase with a user is discussed in more detail with respect to the method of FIG. 7.

Once the purchasing session with the user is complete, user merchant data and product data are updated at step 355. If a sale results, the merchant data is updated with the user's preferred product, bundles engaged or selected, and other data. The product data may be updated based on whether or not there was a sale on products in order to move inventory, the margin, and other product data.

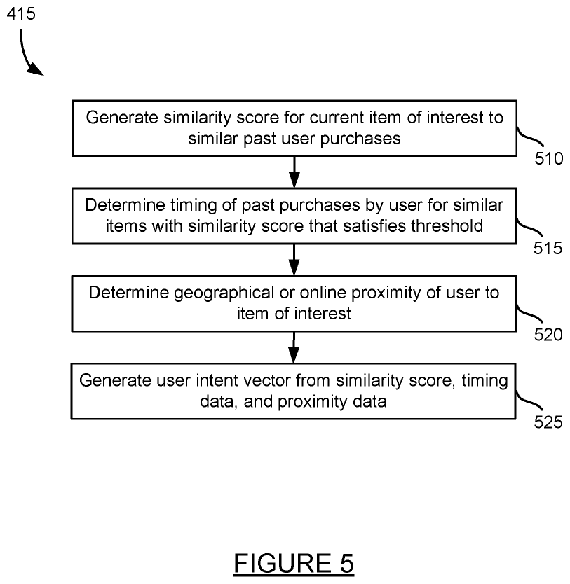

FIG. 4 is a method for confirming a time to provide a bundle. The method of FIG. 4 provides more detail for step 335 of the method of FIG. 3. First, a bundle timing model is trained based on past user merchant activity and product data at step 410. The bundle timing model may be any of several types of modeling techniques which results in the likelihood of the user making a purchase at the current time based on the data received by the model. A user intent vector is generated at step 415. The user intent vector is intended to provide an indication of the user's intent to make a purchase or strike a deal with the service. More details for generating a user intent vector are discussed with respect to the method of FIG. 5.

The bundle timing model is updated based on the current user geographical data and/or online navigational data and the user intent vector at step 420. The model may then output timing information which may be translated into a timing score at step 425. A determination is then made as to whether the timing score indicates the user is likely to make a purchase at step 430 if presented with a bundle offer. If the timing score indicates the user is not likely to make a purchase, then the system determines that one or more bundles should not be prepared at step 440. If the time score indicates the user is likely to make it purchase if a bundle offer is presented, one or more bundles are generated at step 435.

Variations of the method for determining the timing to make a bundle are within the scope of the present technology. For example, in some instances, bundle offers are made if a user is close to making a purchase but not 100% committed to the purchase. In this way the bundle is used to increase conversion for the merchant.

FIG. 5 is a method for generating a user intent vector. The method of FIG. 5 provides more detail for step 415 of the method of FIG. 4. A similarity score is generated for the current item of interest to similar past user purchases at step 510. The similarity score may be based on the category of the current item and pass user purchases and rich profile information for the user and products. In some instances, the similarity score reflects what products go together or are typically purchased together by the current user or other users. A level of granularity for the products to go together may be, for example, a specific dress that matches a subset of shoes based on color and style. Similarly, the products that are purchased together may both be food type products, such as milk and bread. The correlation granularity may be for its population as a whole, maybe based on demographic or psychographic data, it may be generated for a clustered set of users or an individual user.

In some instances, a similarity score may be used to identify items other than products available for purchase. For example, a similarity score can be used to determine a number of points at which a user may be more likely to complete a purchase of an item of interest.

A timing of past purchases by the user for similar items having a similarity score that satisfies a threshold is determined at step 515. In some instances, this will determine if past purchases similar to the current item of interest have been purchased on a regular schedule or periodically by the user. If the determination identifies past purchases with a high similarity score to that satisfies a threshold, this will indicate that the user likely has an intent to purchase a product.

A geographical or online proximity is determined between the user to an item of interest at step 520. In other words, if a user enters the store and walks up to a particular product of interest, or goes online to the merchant web site and navigates to a particular page having the product, this will be determined as a close proximity to the product and indicative of an intent to purchase a product.

A user intent vector is generated from the similarity score, timing data, and proximity data at step 525. User intent vector may be generated as a weighted product of each factor. In some instances, if a similarity score, timing data, or proximity data is very high, this might be considered more heavily than other factors which may not be as high.

FIG. 6 is a method for preparing one or more bundles for a user. FIG. 6 provides more detail for step 340 of the method of FIG. 3. First, a shopping model is retrieved for the user. The shopping model may be retrieved for a group of users or the user individually, depending on the extent of the shopping history the user has. A shopping model may then be updated with past user data, product data, and user proximity data at step 615. A shopping model may be implemented using any type of modeling technique that allows for identifying bundles that would be decided by a user.

A shopping model may be updated with merchant data at step 620. The merchant data may include various targets by the merchant, including revenue, margin data, promotional investment, inventory movement requirements, and other data. Offers most likely to be of interest to the user based on the updated shopping model for the user are identified at step 625. Product similarity may include product set can be used or worn together or our commonly purchased together. The granularity of the product may be in terms of the item and/or category of the product. The system may prepare identified offers for the current purchase at step 625. The offers may be generated according to what is determined to be most desirable to a user. Examples of offers that are bundled with a current item of interest for user are free shipping, discounts on other products, shopping points, products for other merchants, and other offers.

In some instances, the customized products, offers, and bundles of products and offers may be generated by prediction engine 245. Prediction engine 245 may utilize one or more machine learning models to identify the products, offers, and/or bundles customized for the user. In some instances, the input of the machine learning model may include the shopping model data prepared for the user. The output of the machine learning model may provide a prediction as to what products would be best suited to offer to the user. The machine learning model output would identify offers most likely of interest to the user.

FIG. 7 is a method for negotiating a purchase between a user and an automated agent. The method of FIG. 7 provides more detail for step 350 of the method of FIG. 3. Bundles are provided to a user at step 710. The bundles may be provided to the user through a mobile app, text message, website, augmented reality experience through a mobile device, or in some other manner. A determination is made as to whether a user makes a purchase with a bundle at step 715. If the user purchases an item of interest with a particular bundle, the transaction is complete at step 720. If the offer is not accepted, a determination is made as to whether a counteroffer is received from the user at step 725. The counteroffer may be in one of several forms, including a request for multiple bundles, different terms for an existing bundle, or some other counteroffer. If no counteroffer is received, the method stays at step 725.

In some instances, an entire negotiation set of bundles and/or individual offers is personalized and optimized for the user and is only known and available to the user. Therefore, the negotiation offers may not be available to other users or to the same user at a different time.

If a counteroffer is received, a determination is made as to whether the counteroffer is acceptable at step 730. In some instances, bundle generator 225 may include logic, including artificial intelligence, they may determine whether a counteroffer is acceptable. Determination is whether a counteroffer is acceptable may include whether it is in compliance with merchant margins, profits, allowed merchant promotions, and other parameters associated with the merchant and the product itself. If the counteroffer is acceptable, the counteroffers accepted in the transaction is completed at step 735. If a counteroffer is not acceptable, and indications provided to the user that the offers unacceptable at step 740. In this case, additional or new bundles may be prepared and provided to the user at step 745, and the method of FIG. 7 returns the steps 710.

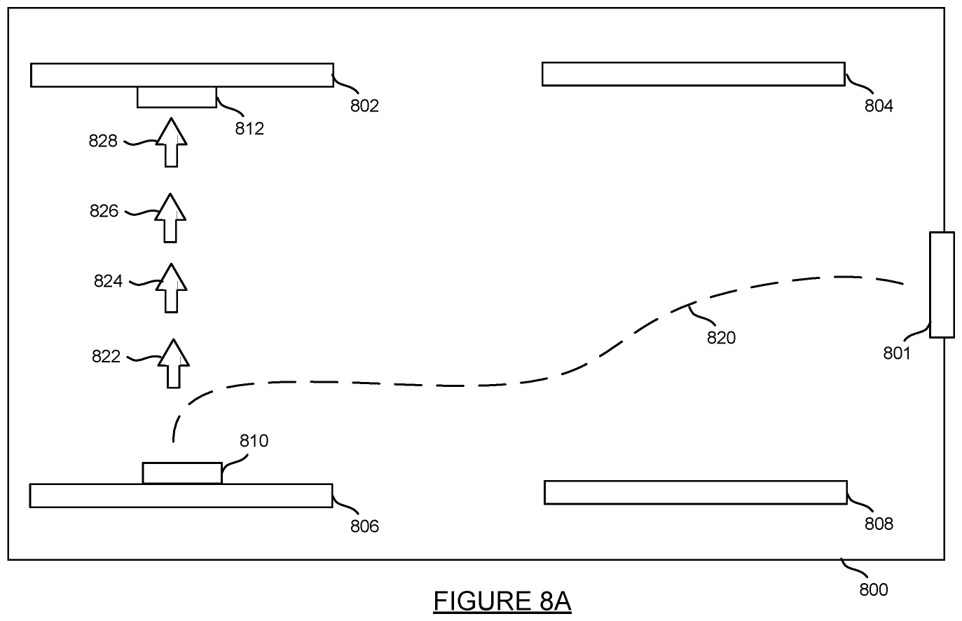

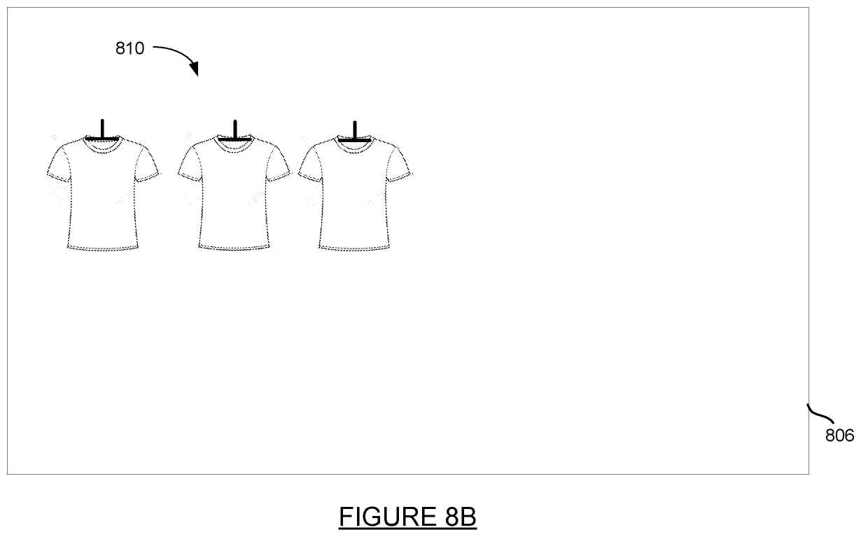

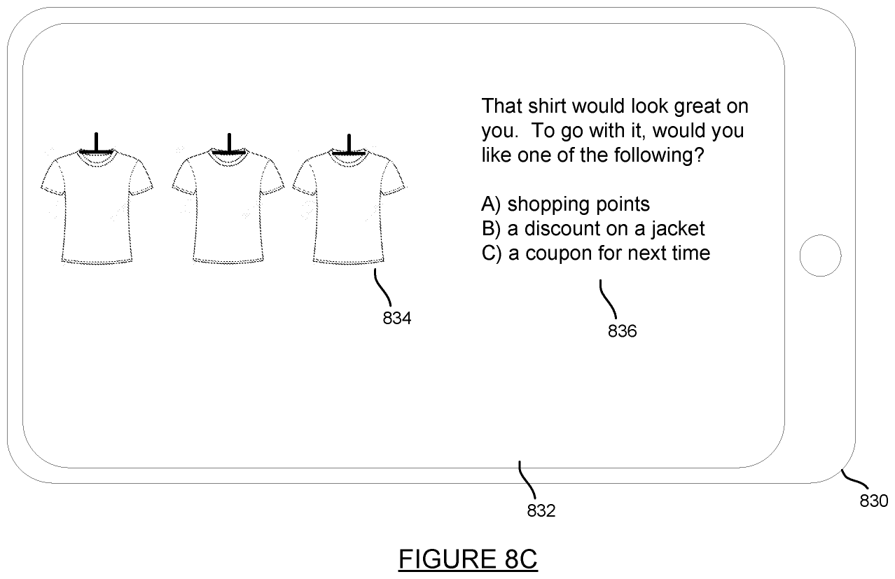

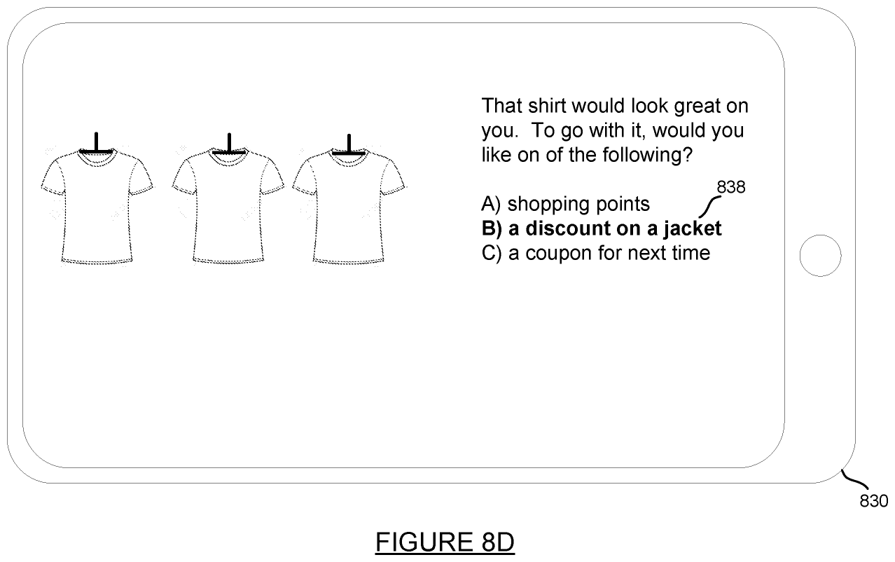

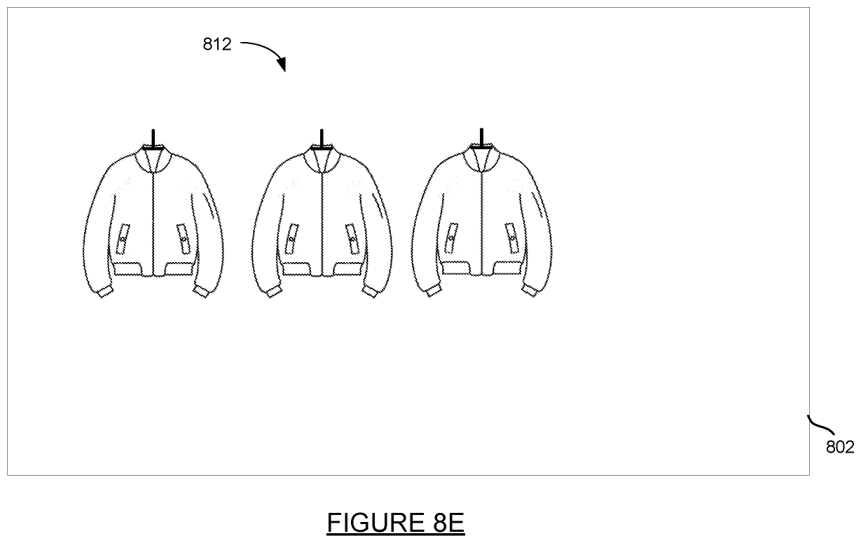

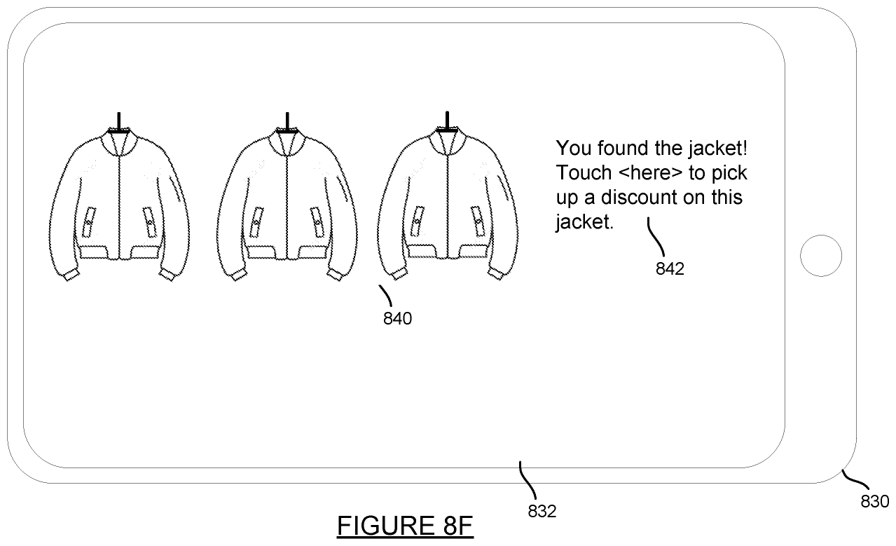

FIGS. 8A-8F illustrates an augmented reality implementation for an intelligent and interactive shopping engine. The AR implementation of FIG. 8A includes a physical store 800. The store includes shopping aisles 802, 804, 806, and 808. Shopping aisle 806 includes a first product 810. Shopping aisle 802 includes a second product 812. For purposes of discussion, the first product will be considered a shirt in the second product will be considered a jacket.

A user may enter the store through door 801. Once within the store, the user's mobile app may detect the geographical location of the user within the store, and send a notification to an application server of the user's geographical location. The user may follow a path 820 through the store and arrive at first product 810 at shopping aisle 806. FIG. 8B illustrates that isle 806 includes first products 810, consisting of one or more shirts hanging within the aisle. Once in front of the first product (shirt), the mobile app may send a notification of the user is currently in the vicinity of or dwelling near the location of the shirt. As a result, the application server may determine that the user is likely to make a purchase at the current time if offered a bundle, and may therefore generate one or more bundles to be displayed to the user. The generated bundles may be provided to a user through an augmented reality experience via the user's mobile device (or other device with AR and/or VR capability). FIG. 8C illustrates the view through the display 832 of a mobile phone 830 of aisle 806 with first product 810 along with bundle data. The bundle data is provided as superimposed text that reads “that shirt with the great on you. To go with it, would you like one of the following?”. The bundles are then specified as “a) shopping points,” “be) a discount on a jacket,” “C) a coupon for next time.” The bundles may be illustrated as text, graphics, icons, or any other content that can be overlaid to the physical objects through the display of mobile device 830. The examples of shopping points, a discount, and a coupon as a bundle in FIG. 8C are exemplary, and other bundles can be made by adding other offers or products to any particular product or offer

As shown in FIG. 8D, a user may select the bundle 838 associated with the discount on a jacket. The selected bundle may be highlighted when a selection is received from the user.

Returning to FIG. 8A, once the user selects the second product, indicators, text, graphics, or other content may be provided through the augmented reality functionality of a mobile application on a mobile device to direct the user to the second product. The virtual direction indicators 822, 824, 826 and 828 may appear within the space of store 800 when viewed through a mobile app which provides the augmented reality experience. Once the user arrives at aisle 802, the user may see the second product consisting of jackets, as illustrated in FIG. 8E. When displayed through mobile device 830, an image 840 of the jackets may be displayed next to additional content 842 which indicates that the user found the jackets as illustrated in FIG. 8F. The user can make a selection to select a discount for the particular jacket. The additional content provided as part of the augmented reality experience may include icons, text, and other content added to the display of mobile device 830.

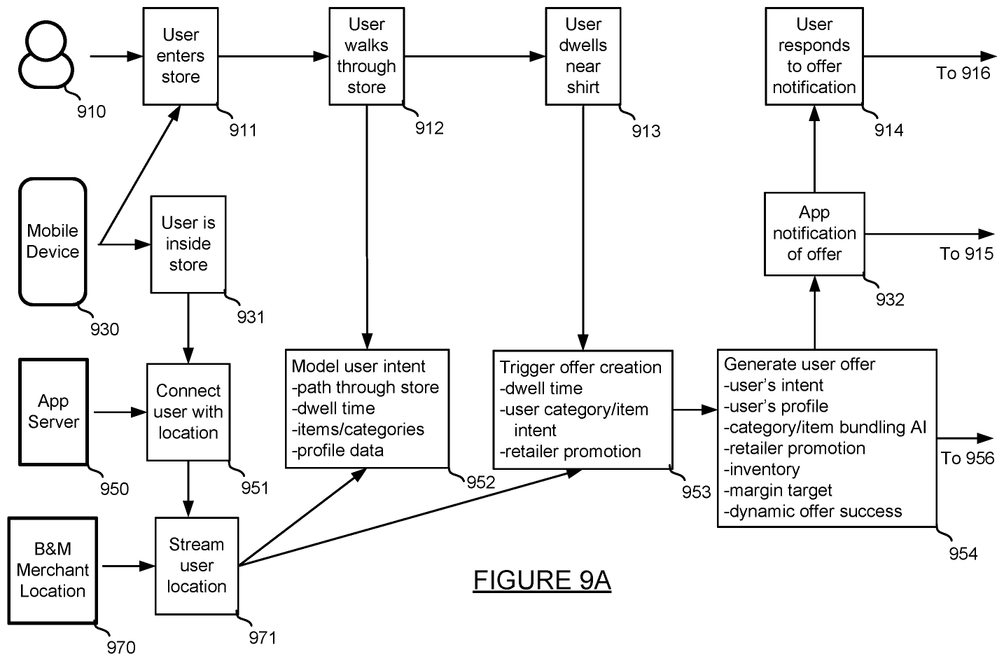

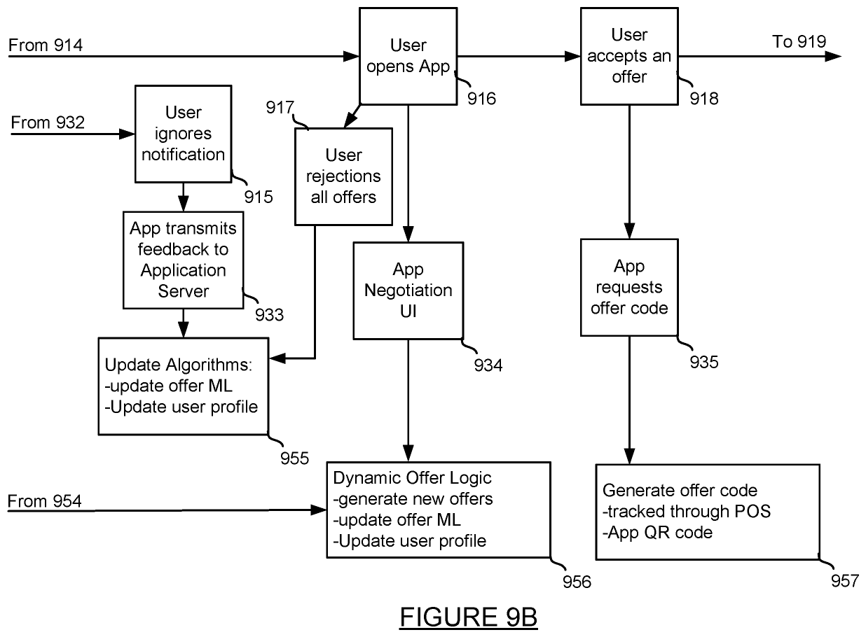

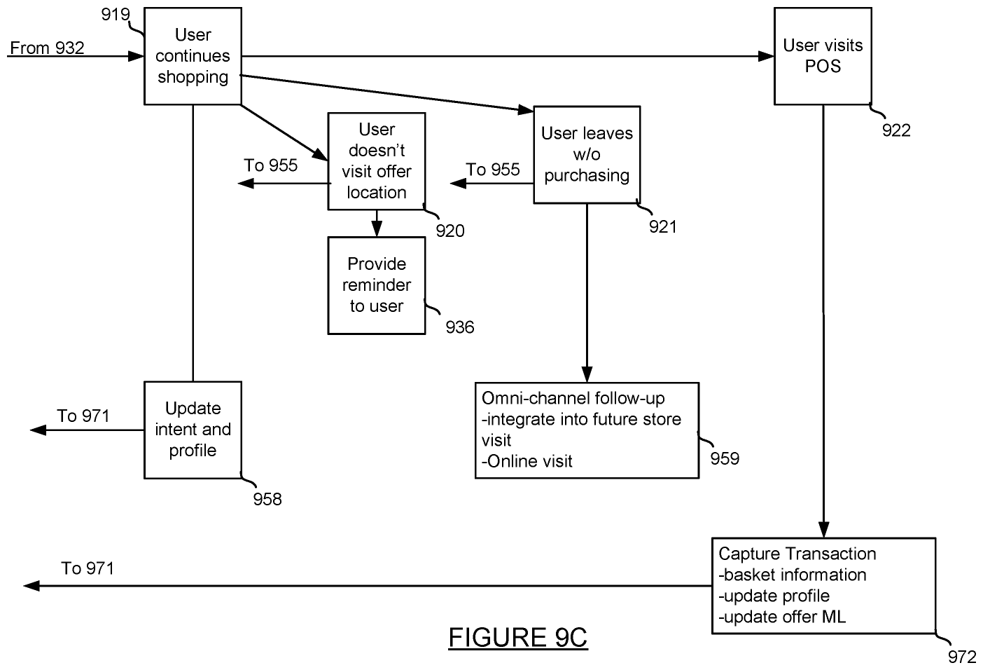

FIGS. 9A-9C illustrate a flowchart of an exemplary user purchase experience. The user purchase experience of FIGS. 9A-9C relates to a user that navigates a physical store with a mobile app on a mobile device. These are purchase experience steps for a user 910, mobile device 930, server 950, and merchant location 970. A user enters a store at step 911. Once the user enters the store, the mobile device detects that the user is inside the store from geographical data, and sends a message to have server 950 so that the app server can connect the user with the location at step 951. The merchant location may then stream the user location at step 971. The user location stream is used to update the model user intent at step 952 and trigger an offer creation once a user dwells near a product at step 953.

Returning to the user, the user walks in the store at step 912 and dwells near a T-shirt product at step 913. Walking through the store causes the model user intent to be updated while strolling you the T-shirt triggers an offer creation moment. The dwell time, user category an item intent, and retailer promotion are used to generate a user offer at step 954 by app server 950. The user offer is based on the user's intent, user's profile, category an item bundling artificial intelligence, retailer promotion and inventory data, the margin target and the dynamic offer success. After generating the user offer, the app is notified of the offer at step 712 and the user mobile device communicates the offer through the mobile app. If the user response to the offer notification at step 914. The user opens the app at step 916. User may then accept the offer at step 918, reject all the offers at step 917, or perform negotiation through user interface at step 934. If a user ignores notification provided on the mobile device, the app transmits feedback to the application server at step 933 and algorithms including models for the user profile and machine learning logic are updated at the app server at step 955. Similarly, if the user rejects all offers once they have opened the app, algorithms are also updated at step 955 accordingly. If the user negotiates one or more offers, dynamic offer logic is used to generate new offers, update user profile, and other update other machine learning logic.

If the user accepts an offer, the app can request and offer code at step 935. The offer code is then generated, and tracked through a point of service through the app provided QR code at step 957.

Continuing to FIG. 9C, if the user accepts the offer but continue shopping at step 919, user intent is updated along with the user profile step 958, and flow returns to step 971 or the user location is streamed. If, after the user continue shopping, the user doesn't visit the offer location, though continues to step 955 the algorithm and machine learning logic are updated. In some instances, a subsequent reminder may be provided to a user at step 936. The user continues shopping and eventually leaves without purchasing the items, the algorithm and machine learning logic are updated at step 955, and the user data for the merchant is updated to integrate the offers into future store visits and online visits at step 959. If after continuing to shop, the user does visit a point of service, the transaction is captured, and the basket information is used to update the user profile and update machine language logic at step 972.

In some instances, the present technology may provide a customized interactive shopping experience to a user that is present within a geographical area associated with a seller. For example, the geographical area include a store, a shopping center, a mall, an outdoor market, a combination of these places, or some other geographical area or areas in which a user location can be tracked in some way.

In summary, a user may navigate through a store or other geographical location with a user device, such as a cell phone. An application on the mobile device may detect the user is within the geographical location and communicate with the user to provide a customized and private shopping experience. The experience can include generation of a custom bundle of products and offers made specially for the user. The customized bundle is based on user profile data, shopping history, geographical location, seller data, store data, and other data. The custom bundle is private and created only for the particular user, based on the most current data regarding the user, product, and seller. The offer is not available to any other user within the geographical location. The interactive experience involves allowing the user to accept or reject the offer, as well as make one or more counteroffers regarding the customized bundle. As a user navigates through the geographical location, different bundles, product specials, and other information may be provided to the user. The information may include augmented reality graphics such as directions to a product or offer location, product offers, and so on.

The present system can generate a bundle of products and/or offers for a user. The generated bundle is custom generated for the specific user, and is not offered or provided to any other user. Each generated bundle is generated based on a data set that can include user profile data, user shopping data, user geographical information, product data, seller sales data, seller preferences, and other data. Before each custom bundle is offered to a user, the most up to date data set is accessed and used to customize the bundle.

Portions of the data set are used to customize the bundle in several ways. User profile data may include data related to user hobbies, age, occupation, and other data that may indicate typical interests or categories of interests. For example, if a user has a hobby of cycling, the system may retrieve products related to bikes and biking accessories. If the user is in her 40s, the system may retrieve products deemed to be of interest to that age group or age range, such as clothing. If the user is an attorney, the system may retrieve products such as dress clothes or executive office supplies.

User shopping data may also be used to generate a custom bundle for a user. If a user has shopped for a particular brand of products before, such as kids shoes, the system may create a bundle by adding kids shoes, kids socks, or kids clothing. If the user has typically paid cash for past purchases, the custom bundle may offer a cash discount for the current bundle. If the user has viewed a particular product in the past, the customized bundle may include the product or a similar product that is found in the geographic location (e.g., store) in which the user is currently detected.

A bundle may be customized based on a user's geographical location and product data. For example, if the user is in a city with a forecast of rain, the bundle may be customized to include an umbrella, rain jacket, or other weather related product. If the user is within a department store, the bundle may be customized with products that are currently on the shelves of the store. In some instances, the bundle may be customized with products that are within a threshold radius of the user, such as 15 feet, 25 feet, 50 feet, or some other distance.

A seller's sales data and seller preference may be used to customize a bundle that is offered to a user. For example, if a store owner wants to sell more of a particular product, the product may be more likely to be included within a bundle. In some instances, an initial set of products may be identified to be included in a custom bundle for a particular user. From that initial set, products may be assigned a weighting corresponding to the desire of the seller to sell the particular product. The seller may assign a higher or lower weighting based inventory, desire to clear stock or make space, whether the number or products currently sold is above or below seller forecast data, or some other reason.

As the user's location is tracked through the geographical location, products of interest to potentially include in a bundle may be identified on an ongoing basis. The products may be those that are in close proximity to the user within a store or within walking distance of the user. For example, if a user is tracked to be at an aisle having cooking utensils in a department store, a bundle may be custom generated for a user that includes one or more cooking utensils. If a user has an interest in sporting good products, a custom bundle that includes sporting apparel or sporting goods may be generated for the user, and the user may be directed through the store towards the sporting apparel or sporting goods.

A user's position within the geographic location can be tracked in any of several ways. In some instances, the location of the user can be determined using a satellite based radio navigation system such as the Global Positioning System (GPS). In some instances, the location of the user can be determined by an Indoor Positioning System (IPS), which can use internal sensors and radio signals to track a user's mobile device as the user navigates around the geographical system.

A customized bundle may be generated for a user upon the occurrence of an offer event. The offer event may be when the user enters the geographical location, the user comes within a threshold proximity of a particular product or other point within the geographical area, a user requests an offer from the service, the user makes a counteroffer that is not accepted, a specified period of time has transpired, or some other event.

Once the offer event occurs, a prediction engine (i.e., artificial intelligence prediction model) may be used to generate the bundle. In some instances, an initial set of bundles, such as 5, 10, 15, 20, or some other number of initial bundles, may be generated for the user based on a data set that includes user profile data, user shopping data, user geographical information, product data, seller sales data, seller preferences, and other data.

In some instances, a prediction model is generated for each bundle, and data related to the current interaction with the user is normalized and fed into each prediction model. The current interaction data may include data relating to the user's shopping history, user's time within the geographic location, the number of offers made to the user and the user counteroffers, and other data. The user customized bundle associated with the highest prediction engine output is selected as the bundle to present to the user at that particular time.

In some instances, a prediction model is established for each of an initial set of products. The initial set of products may be chosen based on user interests and hobbies, seller product preferences, user shopping history, and other data. A set of current interaction data is fed to each prediction engine associated with a product. The current interaction data may include data relating to the user's shopping history, user's time within the geographic location, the number of offers made to the user and the user counteroffers, and other data. The products associated with the highest prediction engine output are selected as the bundle to present to the user at that particular time. The number of products selected may include a set number of products, such as 2, 3, 4, or 5. In some instances, the number of products may be any number for which the total price of the products is within a user desired, automatically determined, or default generated range (such as for example, $10-$15, $30-$50, $80-$100, or some other range).

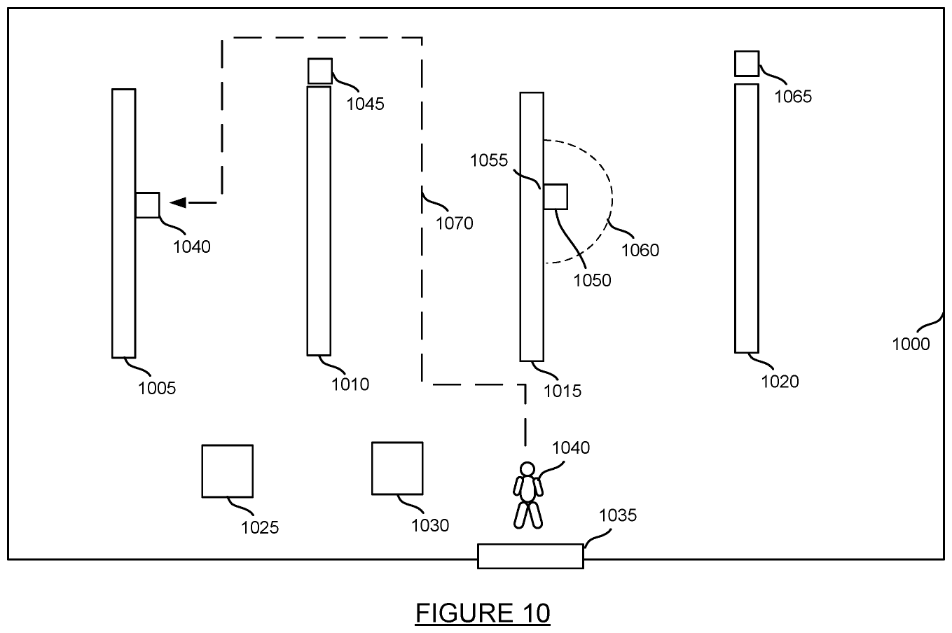

FIG. 10 illustrates a diagram of a geographical location for providing a customized interactive shopping experience. The geographical location 1000 includes a store with product aisles 1005, 1010, 1015, and 1020. The store has checkout counters 1025 and 1030 at which a user can purchase products, redeem offers, and close out transactions related to custom bundles created for the user.

The geographical location includes multiple locations where a user can access special product deals and other offers. Markers 1040, 1045, 1050, and 1065 are each associated with a product or an offer. At each marker, there may be one or more of a scannable code (e.g., QR code, bar code, other code), a proximity sensor (e.g., Bluetooth sensor), or other device that can be used confirm the location of a user's mobile device. In some instances, a user may scan a scannable code to obtain information about the marker, such as the product deal offered or offer available to the user. In some instances, scanning a scannable code may trigger an offer event and initiate a custom bundle being generated for the user, which includes a product or offer associated with the scanned marker.

As a user 1040 enters a geographical location, such as a store, through entry 1035, an executing application (not shown in FIG. 10) prompts the user. The initial prompt may be a welcome to the particular business, followed by an invitation to navigate the store. For example, the application may display information inviting the user to navigate along a path 1070 past one or more aisles in the business to find a marker 1040. The path 1070 may traverse past one or more other markers 1045. When the user navigates close to or up to marker 1045, the application may display an offer, bundle, or other information to the user through the user's device display. The user may interact with the application at marker 1045, or may continue to marker 1040. At marker 1040, the user may be rewarded in some way, for example with a discount on a product, an offer (free shipping, 10% off a product, and so forth), a bundle of products custom generated for the user, or some other offering.

In some instances, as the user's position within geographic area 1000 is tracked, the system can detect when the user is within a threshold distance of a particular marker. For example, when the user is within threshold distance 1060 of marker 1050 in FIG. 10, the application may provide an alert to the user through the user's computing device. The alert may prompt the user to scan a code associated with marker 1050. Upon scanning the code, the system may generate a bundle for the user, or offer a product deal or offer to the user, and communicate the bundle, product deal, or offer to the user through the user's computing device.

In some instances, products, offers, and/or bundles may be communicated to a user through a user's mobile device. These communications may be communicated through the display of the user in the form of text, graphics, animations, and other output as the user views different portions of the geographical location (e.g., different portions of a store as the user navigates the store). In this manner, the data that makes up the products, data, and/or bundle in an augmented reality fashion, which involves displaying the geographical location the user is navigating while superimposing the text, graphics, animations, and other content over the display of the geographic location.

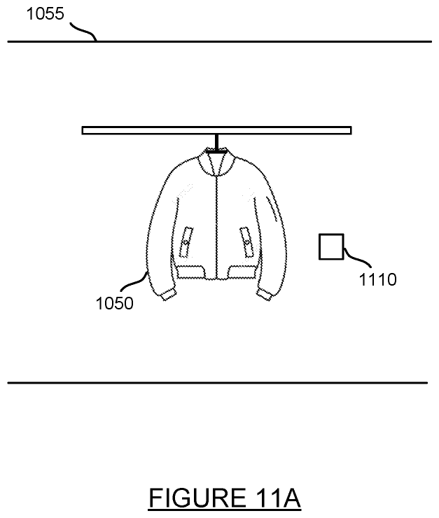

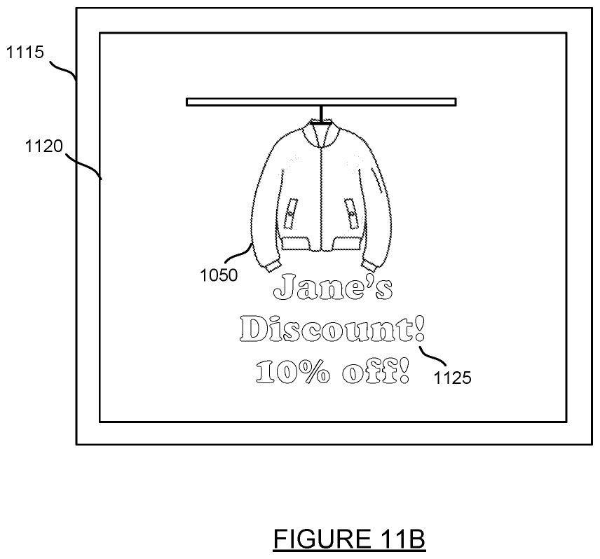

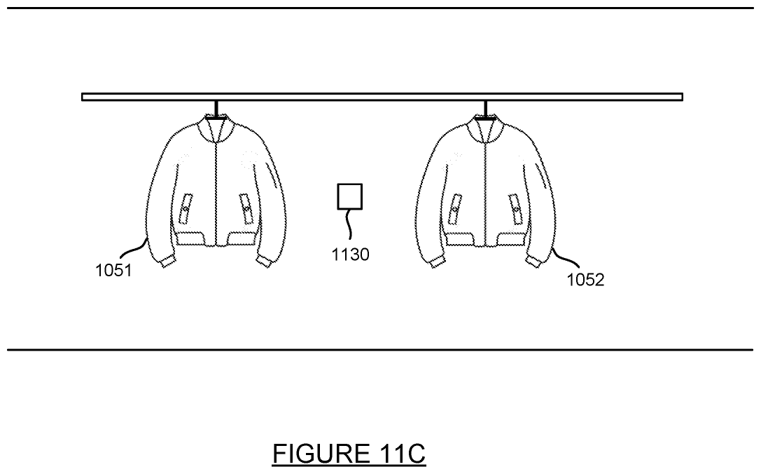

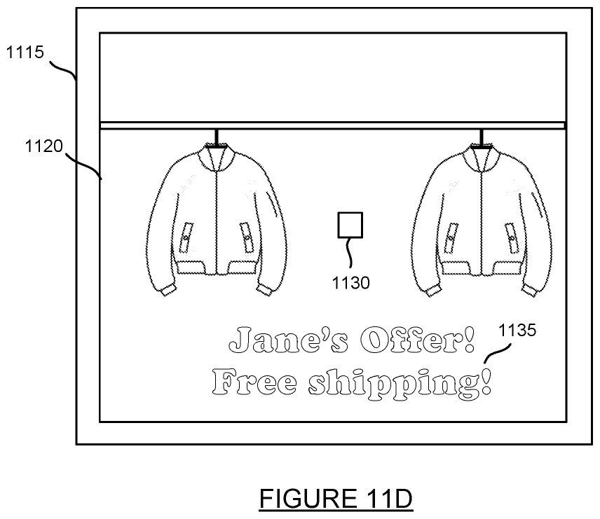

FIG. 11A provides more detail for a product and a corresponding scannable code within the geographical location of FIG. 10. The product 1050 is located at location 1055 next to marker 1110. Marker 1010 may be one or more of any scannable symbol, including but not limited to a QR code, bar code, or some other symbol or code. When a user scans marker 1110 with a computing device, enters a code located on the marker, or otherwise receives information associated with the marker, the application on their mobile device may retrieve information associated with the marker. In some instances, the information can be a bundle, if scanning the marker triggers an offer event. In some instances, the information can be a deal on a product that can be bundled with other products and/or offers.

FIG. 11B illustrates an augmented view of the product and corresponding scannable code of FIG. 11A and a graphic through the display of a computing device. FIG. 11B illustrates an augmented view of product 1050 through a display 1120 of a computing device 1115. The augmented display includes physical item 1050 at the location of marker 1010, as well as information regarding a deal offered to the user for the product. In particular, the information reads, “Jane's Discount! 10% off!” The information is only offered to the user, and the deal associated with the information is custom generated for the particular user.

FIG. 11C provides more detail for a scannable code within the geographical location of FIG. 10. Marker 1130 in FIG. 10 may be located next to one or more products 1051 and 1052 but not necessarily associated with either one. Rather, the marker may be hidden “Easter Egg” style in the geographic location 1000 of FIG. 10.

FIG. 11D illustrates an augmented view of the scannable code of FIG. 11C and a graphic through the display of a computing device. When marker 1130 is scanned, the computing device 1115 may retrieve information associated with a bundle, product, or offer that is generated just for that particular user. The product and/or offer may be incorporated into a bundle that is offered to a user. In FIG. 11D, the information provided to a user reads, “Jane's Offer! Free Shipping!” Hence, the information provided to the user in FIG. 11D relates to an offer for free shipping.

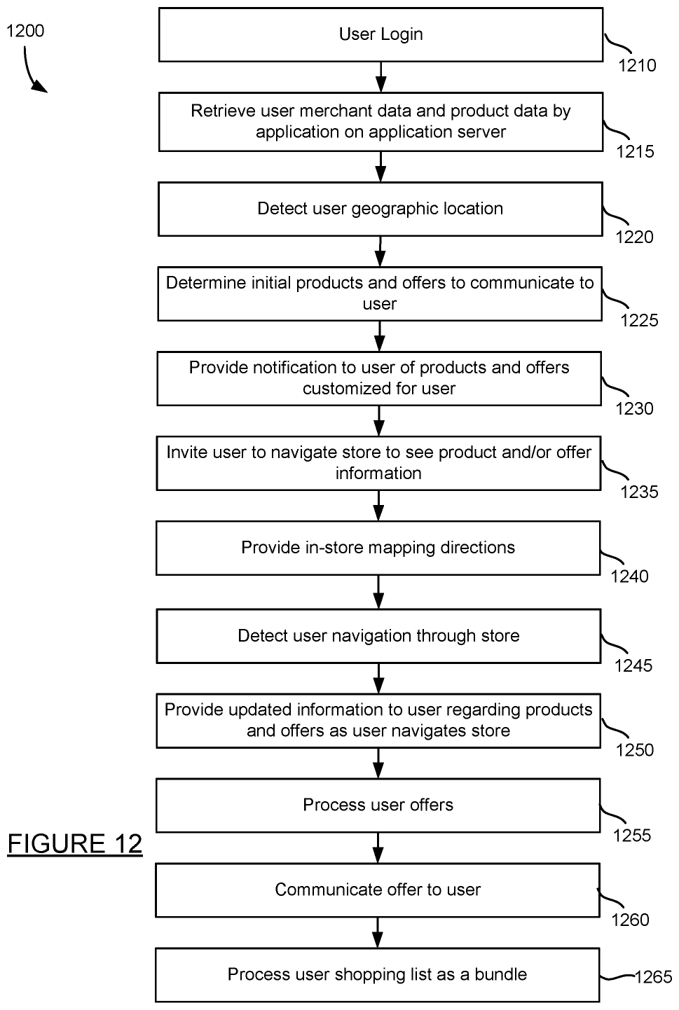

FIG. 12 is a method for providing an on-site intelligent and interactive shopping experience. User login is performed at step 1210. User login may be broadly interpreted as creating a user account, executing a mobile application, logging into a web service, or simply determining that a user's physical location is detected at, within, or near a brick-and-mortar store for a merchant.

User merchant data is retrieved from a merchant server by an application on an application server at step 315. The merchant data may include user purchase information, including online webpages visited, clicks received, and items bought. The user merchant data may also include in-store visit data, including visits to a store, items purchased, items returned, offers and counteroffers made, and other user merchant data. In some instances, the user merchant data may be for more than one merchant. For example, a particular merchant may provide user merchant data for that particular store as well as other merchants, for situations when a bundle may be provided to a user to offer a product or service from a different merchant.

Product data can be retrieved by an application on the application server at step 320. Product data can include inventory, information regarding related products, category information for a product, product cost, product margin, and other data.

A user geographic location may be detected at step 1220. The geographical location may be detected for the user through the user's computing device, such as for example a mobile device along the likes of a cellular phone, tablet, or other device. The geographic location may be provided to an application on the user's device, and then boarded to an application server or some other part of the system.

Initial products and offers to communicate to a user are determined at step 1225. Initial products and offers may be based on the user merchant data, product data, store data, geographic location, user shopping data, and other data discussed herein. This step can involve generating a customized bundle for a user.

In some instances, the customized products, offers, and bundles of products and offers may be generated by prediction engine 245. Prediction engine 245 may utilize one or more machine learning models to identify the products, offers, and/or bundles customized for the user. The machine learning model may use one or more prediction algorithms to identify a product or offer to include in a bundle. In some instances, the input of the machine learning model may include past user data, product data, user proximity data, and merchant data. The output of the machine learning model may provide a prediction as to what products would be best suited to offer to the user.

More details for determining initial products and offers to communicate to a user are discussed with respect to the method of FIG. 6.

Once the initial products and offers are determined, a notification may be provided to a user of those products and offers that are customized for the user at step 1230. The notification may indicate to the user that customized products and offers are available, the location of a product, location of where to find an offer geographically within the store, or in other information regarding the customized initial products and offers.

Users are invited to navigate a geographical location (i.e., brick and mortar store) to see products and/or offer information that have been custom generated for the user at step 1235. For example, in the case of a product, the user may be invited to walk towards a particular aisle, section of the store, department, or specific location within a store to see the particular product. For an offer, the user may be invited to navigate to a portion of a store, an informational board, aisle, or some other location within the store to view information about the offer that was custom generated for the user.

After inviting the user, in-store mapping directions may be provided to the user to get to the particular location at step 1240. The in-store mapping directions may be delivered to the user through the user's mobile device, such as for example a cellular phone or tablet. The directions may indicate augmented reality arrows or other graphical directions, aisle information, a map with directions to navigate to the location, or other in-store mapping directions.

User navigation may be detected as the user traverses throughout the store at step 1245. In some instances, a user's navigation through the store is continuously monitored and provided to other components of the present system so that user products, offers, and other data may be updated continuously. As a user navigates the store, offers on products or the offers themselves may change. As such, updated information is provided to the user regarding products and offers custom generated for the user as the user navigates the store.

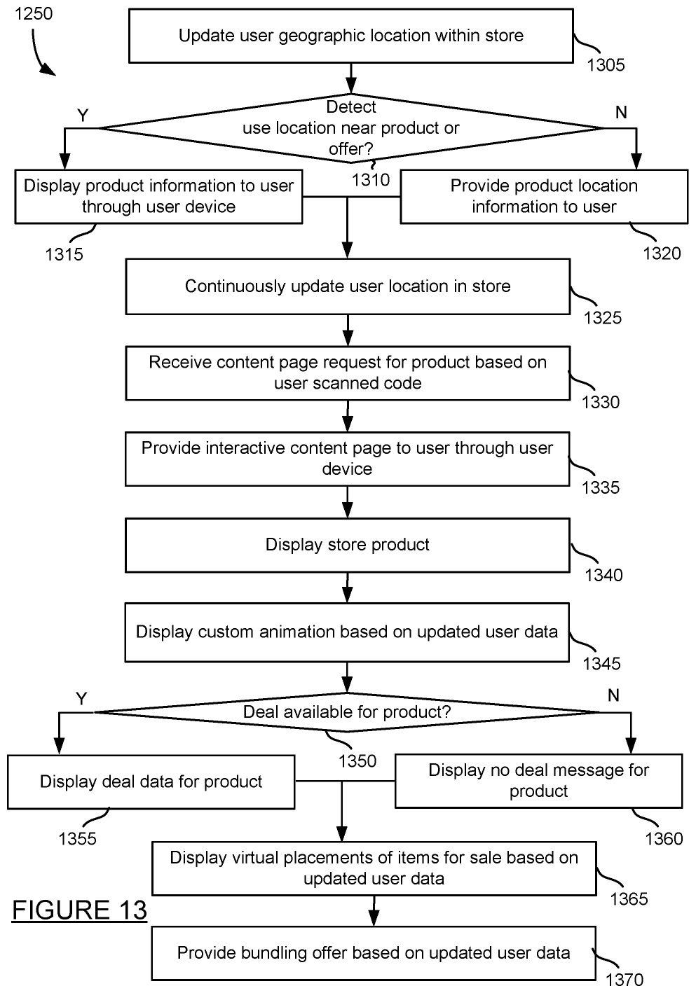

In some instances, the products and offers custom generated for the user will change over time as user navigates through the store. For example, a custom offer for the user may include products that appear to be along the planned navigation route of the user, or within a close proximity to the user as the user's geographic location is detected to change throughout the store. More data for providing updated information to a user regarding products and offers as a user navigates a store is discussed below with respect to the method of FIG. 13.

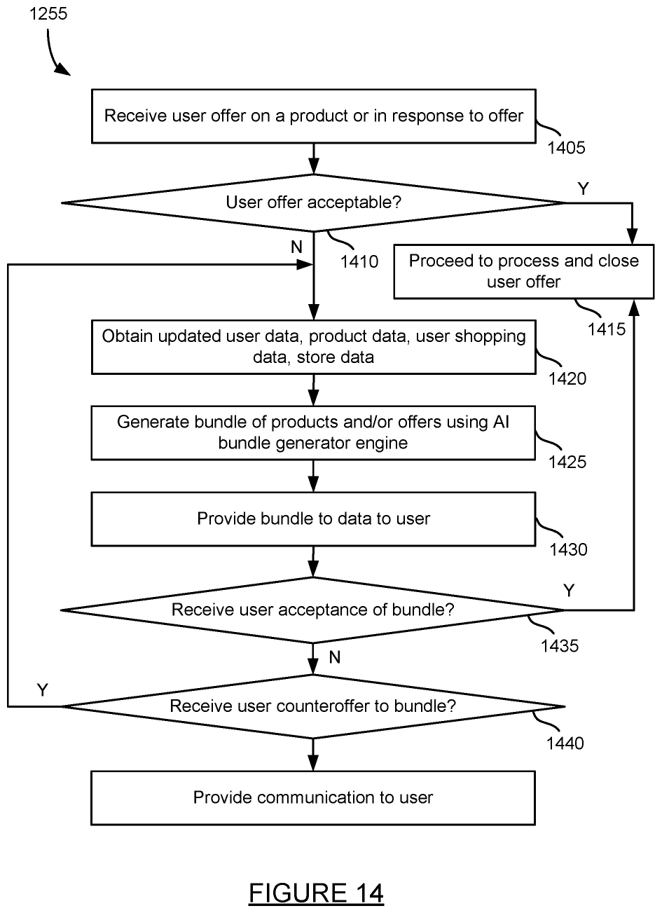

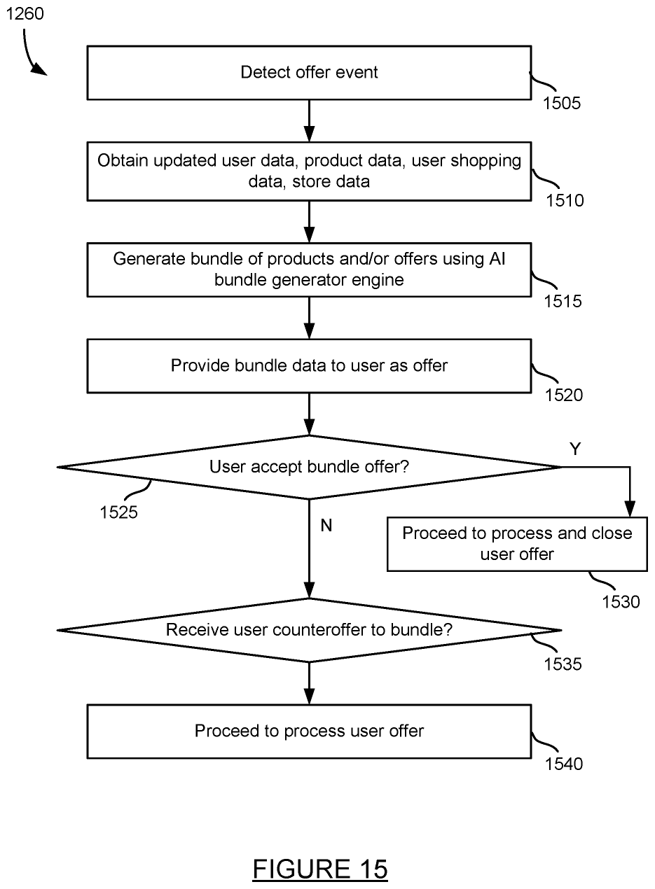

User offers are then processed at step 1255. Processing a user offer may include determining if a user's offer is acceptable, generating bundles of products to offer a user, determining if the user has provided a counteroffer, and other processing. Processing user offers is discussed in more detail below with respect to the method of FIG. 14. An offer may be communicated to user at step 1260. Communicating an offer to user may include detecting an offer event, generating bundles of products and offers, and providing the offer to a user. Communicating an offer to user is discussed in more FIG. 15.

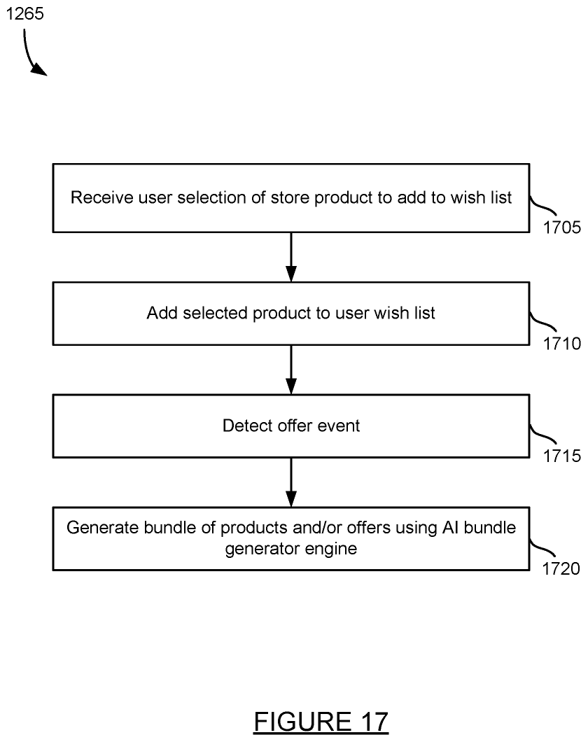

A user shopping list may be processed as a bundle at step 1265. In some instances, a wish list or shopping list can be created by user or other entity, and the list may be used to create a bundle for a user. Processing the user lists as a bundle is discussed in more detail with respect to the method of FIG. 17.

The method of FIG. 12 includes processing user offers, providing updated information to a user, communicating offers to users, and other communications with a user. The communications can be provided to a user through the user's mobile device. In some instances, the communications may be triggered when the user scans a code or icon, such as a QR code, in the store with a camera in their mobile device. By scanning the QR code, an application on the user's phone (e.g., an app associated with the store or the service), can initiate an interactive experience for the user in the store. The interactive experience can include making offers, making counter offers, receiving customized offers and counteroffers, and other activities through the app that are customized for the user.

FIG. 13 is a method for providing updated information to user regarding products and offer as the user navigates a store. The method of FIG. 13 provides more detail for step 1250 the method of FIG. 12. A user geographic location is updated within the store at step 1305. The user's location may be continuously updated, for example using GPS, IPS, or some other positioning system that involves the user's computing device, store location system, a combination of these systems, or some other positioning system.

A determination is then made as to whether the user's location is detected near the location of a product or offer at step 1310. If the user is not detected near a product or offer, product location information may be provided to user at step 1320. The product location information may include directions to a product, an aisle, a department, or some other product location information. The method of FIG. 13 then continues to step 1325.

If the user's location is detected near a product or offer, the product information, or offer information, is displayed to the user through their user device at step 1315. For example, a user may scan a QR code of the product and view information, such as offers or bundles related to the product, with their mobile device display. In some instances, a user device will display a graphic indicating that a product or offer is near the user's current geographic location.

A user's location is continuously updated within a store at step 1325. The location update may happen continuously on the user's mobile device, and the detected location is provided to a backend server. A content page request may be received for a product based on a user scan of a scannable code of image, such as a QR code, at step 1330. Once a user is near a marker associated with a product or an offer, the user may scan a scannable code associated with the product or offer to view information within a content page for that product or offer.

After receiving a content page request, an interactive content page may be provided to the user through the user's device at step 1335. The interactive content page may be displayed through a network browser or a mobile application, and can allow a user to select products, offers, bundles, and/or other content. The store product or offer associated with the scannable code may be displayed through the user's device at step 1340. In some cases, a custom animation may be displayed based on the updated user data at step 1345. Custom animations may be based on the user's location, shopping information, store specials, the customize offer created for the user, or other data.

A determination is made as whether a deal is available for the product that the user has scanned at step 1350. If a deal is not available, a no deal message may be displayed to the user for the particular product at step 1360. The method may then continue to step 1365. If a deal is available for the product, deal data is displayed for the product at step 1355. The method of FIG. 13 then continues to step 1365.

Virtual placements of items for sale may be displayed based on the updated user data at step 1365. The virtual placements may be overlaid on the display of the user's device, such as being overlaid on a video or image being displayed through the user device (i.e., augmented reality). A bundling offer based on the updated user data is generated and provided to the user at step 1370. More details regarding generating a bundle are discussed with respect to step 1420-1430 of FIG. 14.

FIG. 14 is a method for processing user offers. The method of FIG. 14 provides more detail for step 1255 of the method of FIG. 12. User offers are received on a product or in response to an offer at step 1405. A determination is then made as to whether the user offer is acceptable at step 1410. The user offer may be acceptable based on parameters, ranges, or other product owner or seller parameters and aspects of the user's offer. For example, if the user makes a counteroffer within an acceptable price range for the bundle that is set by the seller, or the user counteroffer includes the addition of a product that has a base cost that still makes the bundle offer acceptable to the seller, then the user's counteroffer may be accepted.

If the user offer is acceptable, the system proceeds to process and close the user offer at step 1415. Processing and closing the offer at the brick and mortar store may include generating a bundle identifier, communicating the bundle identifier to the user, and closing the transaction with the user at a store register. The store employee working the register would only need to enter the bundle identifier into the register. In some instances, the bundle generator would be accessible as a code, such as a QR code, displayed on the user's mobile device. The register employee would scan the code, the total amount due would be brought up, and the user would pay for the bundle.

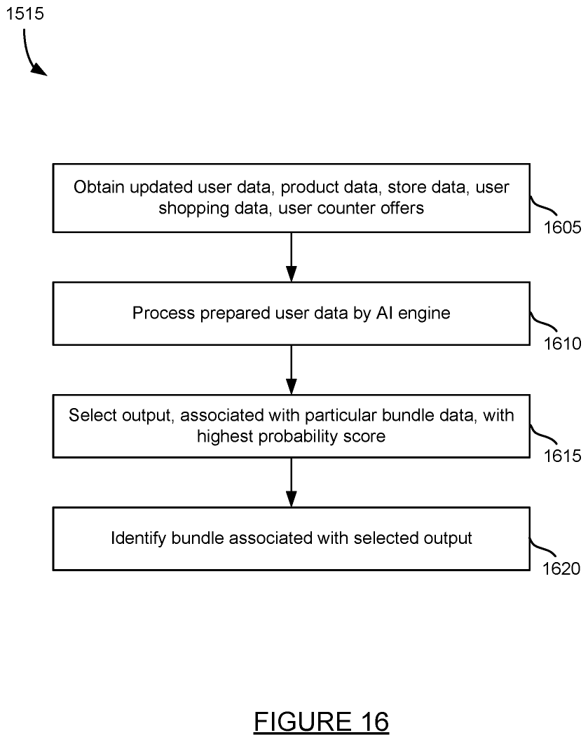

If the offer is not acceptable, data is acquired to generate a new, customized offer for the user. At step 1420, the system may obtain updated user data, new product data, user shopping data, and store data. A bundle of products and/or offerings may then be generated using an artificial intelligence bundle generator engine at step 1425. Generating a bundle is discussed in more detail with respect to the method of FIG. 16.

The private and customized bundle data is provided to the user at step 1430. A determination is then made as to whether the acceptance is received from the user for the bundle at step 1435. If the user accepts the bundle, then the system proceeds to process and close the user offer at step 1415. If the user does not accept the bundle, a determination is made as to whether a counteroffer to the bundle is received from the user at step 1440. If no counteroffer is received from the user, a communication is provided to the user at step 1445. The communication may indicate no counteroffer was received, and invite the user to make a counteroffer or find another product for a bundle, or some other communication. If a counteroffer is received from the user at step 1440, the method of FIG. 14 returns to step 1410.

The present system allows a user and the present system to exchange offers and counteroffers multiple times. If the system makes an offer and the user makes a counteroffer, and the counteroffer is not accepted (or vice versa—the user makes an offer and the system makes a counteroffer, and the user does not accept the counter offer), the cycle of offer and counteroffer does not end. The cycle can continue with additional offers and/or counteroffers, and either party to the negotiation can make a new offer or make a counteroffer in response to an offer or counteroffer by the other party.

In some instances, the present system can combine an in-store product or offer with an on-line product or offer to generate a bundle. The on-line product or offer may include product that is currently out of stock, in-stock at another store, or not sold in stores. The on-line offer may include a discount, shopping rewards, free shipping, or some other offer related to on-line shopping. In some instances, the present system may use one or more prediction engines (e.g., machine learning models) that are tuned and/or trained to offer online products and/or offers for users that may be more likely to accept a bundle that includes on-line products or offers with in-store products or offers. In some instances, a user may also combine an in-store product, offer, and/or bundle with an on-line product, offer, and/or bundle.

FIG. 15 is a method for communicating offers to a user. The method of FIG. 15 provides more detail for step 1260 the method of FIG. 6. An offer event is detected at step 1505. Data is an acquired in order to generate a bundle for a user. As such, the system obtains updated user data, product data, user shopping data, store data, and other data at step 1510. A bundle of products and/or offers is generated using an artificial intelligence bundle generator engine at step 1515. Bundle data is provided to the user as an offer at step 1520. The bundle data may include the one or more products or offers generated at step 1515. More detail for step 1520 is discussed with respect to the method of FIG. 16.

A determination is made as to whether the user accepts the bundle offer at step 1525. If the user does accept the bundle offer, the system proceeds to process and close the user offer at step 1530. If the user does not accept the bundle offer, a determination is made as to whether the system has received a counteroffer from the user to the bundle at step 1535. If a counteroffer is not received from a user, a communication is provided to the user at step 1540. The communication may indicate that the user can submit a counteroffer, can submit a new offer, or can look for another product within the store. If a user counteroffer is received at step 1535, the method of FIG. 15 continues to step 1410 of FIG. 14 to process the offer.

FIG. 16 is a method for providing bundle data to the user as an offer. The method of FIG. 16 provides more detail for step 1520 of the method of FIG. 15. The system obtains updated user data, product data, store data, user shopping data, user counteroffers, and past bundle data at step 1605. The obtained data is then processed for consumption by an AI engine at step 1610. Processing may include putting the data into a format that is consumable by the AI engine. The prepared data is then processed by the AI engine at step 1615. The AI engine receives the obtained and process data, processes the data, and provides a series of outputs. An output associated with particular bundle data with the highest probability score is then selected at step 1620. The highest probability score relates to the likelihood of a user acceptance while maintaining a desirable profit for a seller. The bundle associated with the selected output is identified at step 1625.

FIG. 17 is a method for processing a user shopping list is a bundle. A user selection of a store product to add to wish list is received at step 1705. The wish list may be maintained by the store in which the user is navigating or third-party service. The selected product is added to the user's wish list at step 1710. An offer event can be detected at step 1715. Once a bundle event is detected, a bundle of products and/or offers is then generated using an AI bundle generator engine at step 1720. The bundle is generated based on products and offers from the user's wish list.

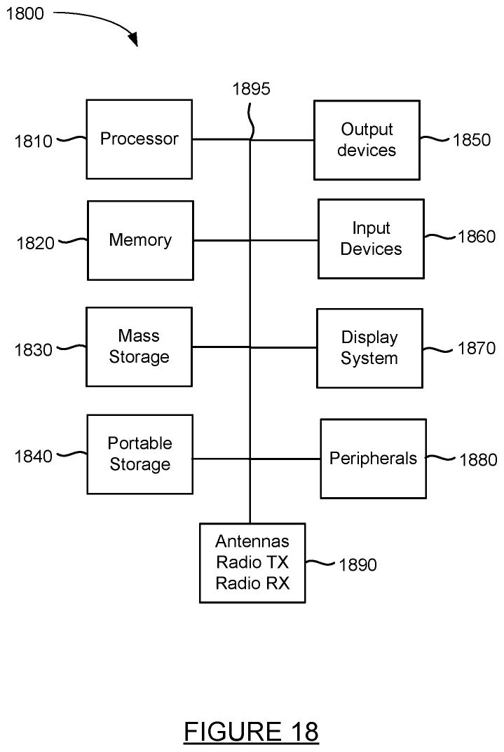

FIG. 18 is a block diagram of a computer system 1800 for implementing the present technology. System 1800 of FIG. 18 may be implemented in the contexts of the likes of computing device 110, mobile device 120, application server 140, and merchant servers 150-170.

The computing system 1800 of FIG. 18 includes one or more processors 1810 and memory 1820. Main memory 1820 stores, in part, instructions and data for execution by processor 1810. Main memory 1810 can store the executable code when in operation. The system 1800 of FIG. 18 further includes a mass storage device 1830, portable storage medium drive(s) 1840, output devices 1850, user input devices 1860, a graphics display 1870, and peripheral devices 1880.

The components shown in FIG. 18 are depicted as being connected via a single bus 1890. However, the components may be connected through one or more data transport means. For example, processor unit 1810 and main memory 1820 may be connected via a local microprocessor bus, and the mass storage device 1830, peripheral device(s) 1880, portable or remote storage device 1840, and display system 1870 may be connected via one or more input/output (I/O) buses.

Mass storage device 1830, which may be implemented with a magnetic disk drive, an optical disk drive, a flash drive, or other storage type, is a non-volatile storage device for storing data and instructions for use by processor unit 1810. Mass storage device 1830 can store the system software for implementing embodiments of the present technology for purposes of loading that software into main memory 1820.

Portable storage device 1840 operates in conjunction with a portable non-volatile storage medium, such as a compact disk, USB drive, external hard drive, digital video disk, magnetic disk, flash storage, etc. to inputs and output data and code to and from the computer system 1800 of FIG. 18. The system software for implementing embodiments of the present invention may be stored on such a portable medium and input to the computer system 1800 via the portable storage device 1840.

Input devices 1860 provide a portion of a user interface. Input devices 1860 may include an alpha-numeric keypad, such as a keyboard, for inputting alpha-numeric and other information, a pointing device, such as a mouse, a trackball, stylus, or cursor direction keys, a touch screen display for receiving touch input, a microphone for receiving audio input, and one or more cameras for capturing gesture input. Additionally, the system 1800 as shown in FIG. 18 includes output devices 1850. Examples of suitable output devices include speakers, printers, network interfaces, image projectors, and monitors.

Display system 1870 may include a liquid crystal display (LCD), an LED display, or other suitable display device. Display system 1870 receives textual and graphical information, and processes the information for output to the display device. In some instances, a display within display system 1870 may also operate as an input device as discussed with respect to input devices 1860.

Peripherals 1880 may include any type of computer support device to add additional functionality to the computer system. For example, peripheral device(s) 1880 may include a modem or a router, speaker, or other peripheral.

When implementing a mobile device such as smart phone or tablet computer, the computer system 1800 of FIG. 18 may include one or more antennas, radios, and other circuitry 1890 for communicating over wireless signals, such as for example communication using Wi-Fi, cellular, or other wireless signals.

The components contained in the computer system 1800 of FIG. 18 are those typically found in computer systems that may be suitable for use with embodiments of the present invention and are intended to represent a broad category of such computer components that are well known in the art. Thus, the computer system 1800 of FIG. 18 can be a personal computer, handheld computing device, smart phone, mobile computing device, tablet computer, workstation, server, minicomputer, mainframe computer, smart device ((e.g., an Internet of Things or IoT device), or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, iOS, ANDROID, as well as languages including Python, PHP, Java, Ruby, .NET, C, C++, Node.JS, SQL, and other suitable languages.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for providing an on-site intelligent shopping experience, comprising:
determining a user location within a geographical location, the geographical location associated with one or more products and one or more merchants;
receiving product data, the product data associated with a product of the one or more products within the geographical location;
receiving user merchant data for a merchant associated with the product that is associated with the product data;
generating a customized bundle for the user, the customized bundle not generated for any other user within the store, the customized bundle based on the user location, merchant data, and product; and
communicating bundle data associated with the customized bundle to the user when the user is detected to be at a position within the geographical location associated with the product.

2. The method of claim 1, wherein the geographic location is a store provided by a merchant.

3. The method of claim 1, wherein the steps of receiving product data, receiving merchant data, and generating a customized bundle for the user are triggered by the user scanning a QR code with a mobile device.

4. The method of claim 1, wherein the customized bundle is generated using a prediction engine that uses machine learning algorithms to predict a product or service to include in a bundle.

5. The method of claim 1, further comprising:
generating content to direct the user along a path within the geographic location; and
providing the content to the user through a mobile device associated with the user.

6. The method of claim 5, wherein the path navigates the user past a product of interest identified specifically for the user.

7. The method of claim 1, wherein communicating the bundle data includes communicating the bundle to the user through the user's mobile device using augmented reality.

8. The method of claim 7, wherein the bundle data is communicated to the user with text and graphics provided within the user's display as the user is viewing the geographic location through the user's mobile device screen as captured by the mobile device camera.

9. The method of claim 1, wherein the customized bundle generated for the user is generated at least in part from at least one in-store product or offer and at least one product or offer provided by the one or more merchants.

10. The method of claim 1, further comprising:
Wherein the bundle data is communicated to the user as a bundle offer;
Receiving a counteroffer to the bundle offer from the user while the user is within the geographical location;

11. The method of claim 1, further comprising:
Receiving an offer from a user while the user is in the geographical location, wherein the bundle data is communicated to the user as a bundle counteroffer in response to the user's offer.

12. A non-transitory computer readable storage medium having embodied thereon a program, the program being executable by a processor to perform a method for providing an on-site intelligent shopping experience, the method comprising:
determining a user location within a geographical location, the geographical location associated with one or more products and one or more merchants;
receiving product data, the product data associated with a product of the one or more products within the geographical location;
receiving user merchant data for a merchant associated with the product that is associated with the product data;
generating a customized bundle for the user, the customized bundle not generated for any other user within the store, the customized bundle based on the user location, merchant data, and product; and
communicating bundle data associated with the customized bundle to the user when the user is detected to be at a position within the geographical location associated with the product.

13. The non-transitory computer readable storage medium of claim 12, wherein the geographic location is a store provided by a merchant.

14. The non-transitory computer readable storage medium of claim 12, wherein the steps of receiving product data, receiving merchant data, and generating a customized bundle for the user are triggered by the user scanning a QR code with a mobile device.

15. The non-transitory computer readable storage medium of claim 12, wherein the customized bundle is generated using a prediction engine that uses machine learning algorithms to predict a product or service to include in a bundle.

16. The non-transitory computer readable storage medium of claim 12, further comprising:
generating content to direct the user along a path within the geographic location; and
providing the content to the user through a mobile device associated with the user.

17. The non-transitory computer readable storage medium of claim 16, wherein the path navigates the user past a product of interest identified specifically for the user.

18. The non-transitory computer readable storage medium of claim 12, wherein communicating the bundle data includes communicating the bundle to the user through the user's mobile device using augmented reality.

19. The non-transitory computer readable storage medium of claim 18, wherein the bundle data is communicated to the user with text and graphics provided within the user's display as the user is viewing the geographic location through the user's mobile device screen as captured by the mobile device camera.

20. The non-transitory computer readable storage medium of claim 12, wherein the customized bundle generated for the user is generated at least in part from at least one in-store product or offer and at least one product or offer provided by the one or more merchants.

21. The non-transitory computer readable storage medium of claim 12, further comprising:
wherein the bundle data is communicated to the user as a bundle offer,
receiving a counteroffer to the bundle offer from the user while the user is within the geographical location;

22. The non-transitory computer readable storage medium of claim 12, further comprising:
receiving an offer from a user while the user is in the geographical location, wherein the bundle data is communicated to the user as a bundle counteroffer in response to the user's offer

23. A system for providing an on-site intelligent shopping experience, comprising:
one or more servers, wherein each server includes a memory and a processor; and
one or more modules stored in the memory and executed by at least one of the one or more processors to determine a user location within a geographical location, the geographical location associated with one or more products and one or more merchants, receive product data, the product data associated with a product of the one or more products within the geographical location, receive user merchant data for a merchant associated with the product that is associated with the product data, generate a customized bundle for the user, the customized bundle not generated for any other user within the store, the customized bundle based on the user location, merchant data, and product, and communicate bundle data associated with the customized bundle to the user when the user is detected to be at a position within the geographical location associated with the product.
